(19) United States
(12) Patent Application Publication
(10) Pub. No.: US 2015/0286487 A1
(43) Pub. Date: Oct. 8, 2015

(54) SYSTEM FOR MONITORING AND ANALYZING APPLICATION DATA TO PROACTIVELY OFFER ASSISTANCE

(71) Applicant: CafeX Communications Inc., Boston, MA (US)

(72) Inventor: Kevin Glass, Cardiff (GB)

(73) Assignee: CafeX Communications Inc., Boston, MA (US)

(21) Appl. No.: 14/678,073

(22) Filed: Apr. 3, 2015

Related U.S. Application Data
(60) Provisional application No. 61/975,392, filed on Apr. 4, 2014.

(51) Int. Cl. G06F 9/44; H04L 29/08; G06F 3/0484

(52) U.S. Cl. CPC G06F 9/4446; G06F 3/0484; H04L 67/22

(57) ABSTRACT

A system for monitoring and analyzing application data to offer assistance is disclosed. In particular, the system may monitor and track a user's usage of a selected software application. Based on the monitoring and tracking, the system may determine if the usage of the application triggers a rule associated with the application. If the usage of the application is determining to trigger the rule, the system may determine that the user of the application needs assistance with the application or otherwise. If the user is determined to need assistance, the system may then modify a portion of the application to enable the user to access the assistance provided by the system. The portion of the application and the assistance may be modified by on the monitored usage and based on information associated with the user.

### CROSS-REFERENCE TO RELATED APPLICATIONS

This application claims priority to U.S. Provisional Patent Application No. 61/975,392 filed on Apr. 4, 2014, the contents of which are hereby incorporated by reference in their entirety.

### FIELD OF THE INVENTION

The present application relates to techniques for monitoring application usage and providing assistance to users, and more particularly, to a system for monitoring and analyzing application data to proactively offer assistance.

### BACKGROUND

Currently, users utilize and access a wide variety of technologies to perform a broad variety of tasks and functions. For example, users often utilize a web browser to access a website or application produced by a provider so as to conduct business transactions, perform work, interact with gaming applications, access media content and information, interact with other users, participate in social media, or perform a variety of other tasks and functions. When accessing such websites or applications produced by providers, users may encounter situations where they may need additional information or may have questions that are not necessarily directly provided or answered by the websites or applications themselves. In such situations, providers often provide users with a call center contact number to allow users to speak directly with a call center agent, provide online customer support options that may assist the users in obtaining the additional information that they seek, or provide some combination of live and online assistance.

Nevertheless, such solutions provided by providers often require a user to actively seek out the assistance, search through various web pages for a call center contact number, spend significant amounts of time with a call center agent who may not ultimately be the optimal call center agent for dealing with the user's specific issues, and spend considerable amounts of time searching through the various online customer support options to determine which support option is most relevant to the user's specific issues. Additionally, current solutions for providing assistance may not actually provide the type of assistance that a user is searching for, and may not be tailored to each individual user's needs, characteristics, and behaviors. Furthermore, current assistance solutions often do not provide users with a seamless and user-integrated experience.

### SUMMARY

A system and accompanying methods for monitoring and analyzing application data to proactively offer assistance are disclosed. In particular, the system and methods may allow a combination of client and server software development kits (SDKs), an intelligent gateway, and a flexible rules-driven context server to provide a dynamic and flexible end-to-end infrastructure for managing and sharing data between applications and contact/call centers. This combination may be utilized by the systems and methods to deliver a seamless and user-integrated experience for users seeking various types of assistance from such contact/call centers. Specifically, a first application may be developed using a SDK, and the first application may then be utilized to monitor and capture a selected user's usage of a selected application. Once the first application monitors and captures the selected user's usage of the selected application, the system and methods may be utilized to determine if the usage triggers one or more rules and/or triggers residing on the context server.

If the usage performed by the user triggers one or more rules and/or triggers residing on the context server, the systems and methods may then include determining that the user of the selected application needs assistance. In certain embodiments, if the user is determined to need assistance, then the systems and methods may include modifying a portion of the selected application. The modified portion of the selected application may enable the user to connect with an agent of the contact/call center, connect with an online support system, connect with a virtual agent, or connect with other types of assistance. Additionally, the modified portion of the selected application and the type of assistance provided to the user may be adjusted based on information collected about the user, based on the user's usage of the selected application, based on the user's behaviors, or based on any other desired factors. Once the user connects with an agent, online support system, or other type of assistance mechanism, the user may receive the assistance accordingly.

In one embodiment, a system for monitoring and analyzing application data to proactively offer assistance is disclosed. The system may include a memory that stores instructions and a processor that executes the instructions to perform various operations of the system. In particular, the system may perform an operation that includes the monitoring the usage of an application. In certain embodiments, the usage may be performed by a user of the application and/or a device associated with the user. Based on the monitoring of the usage, the system may perform an operation that includes determining if the usage of the application triggers a rule associated with the application. If the system determines that the usage of the application triggers the rule associated with the application, the system may perform an operation that includes determining that the user of the application needs assistance from the system or otherwise. Furthermore, the system may perform an operation that includes modifying a portion of the application if the user of the application is determined to need the assistance from the system. The modified portion of the application may be modified based on the usage and on information associated with the user, and may also enable the user to access the assistance from the system.

In another embodiment, a method for monitoring and analyzing application data to proactively offer assistance is disclosed. The method may include utilizing a memory that stores instructions, and a processor that executes the instructions to perform the various functions of the method. The method may include monitoring the usage of an application. In certain embodiments, the usage of the application may be performed by a user and/or a device associated with the user. Additionally, the method may include determining if the usage of the application triggers a rule associated with the application. Furthermore, the method may include determining that the user of the application needs assistance if the usage of the application is determined to trigger the rule associated with the application. Moreover, the method may include modifying a portion of the application if the user of the application is determined to need the assistance. The modified portion of the application may be modified based on the usage and on information associated with the user, and may also enable the user to access the assistance.

According to yet another embodiment, a computer-readable device having instructions for monitoring and analyzing application data to proactively offer assistance is provided. The computer instructions, which when loaded and executed by a processor, may cause the processor to perform operations including: monitoring the usage of an application, wherein the usage is performed by a user of the application; determining if the usage of the application triggers a rule associated with the application; determining that the user of the application needs assistance if the usage of the application is determined to trigger the rule associated with the application; and modifying a portion of the application if the user of the application is determined to need the assistance, wherein the portion of the application enables the user to access the assistance.

These and other features of the systems and methods for monitoring and analyzing application data to proactively offer assistance are described in the following detailed description, drawings, and appended claims.

### BRIEF DESCRIPTION OF THE DRAWINGS

FIG. 1 is a schematic diagram of a system for monitoring and analyzing application data to proactively offer assistance according to an embodiment of the present disclosure.

FIG. 2 is a flow diagram illustrating a sample method for monitoring and analyzing application data to proactively offer assistance according to an embodiment of the present disclosure.

FIG. 3 is a schematic diagram of a machine in the form of a computer system within which a set of instructions, when executed, may cause the machine to perform any one or more of the methodologies or operations of the systems and methods for monitoring and analyzing application data to proactively offer assistance.

### DETAILED DESCRIPTION OF THE INVENTION

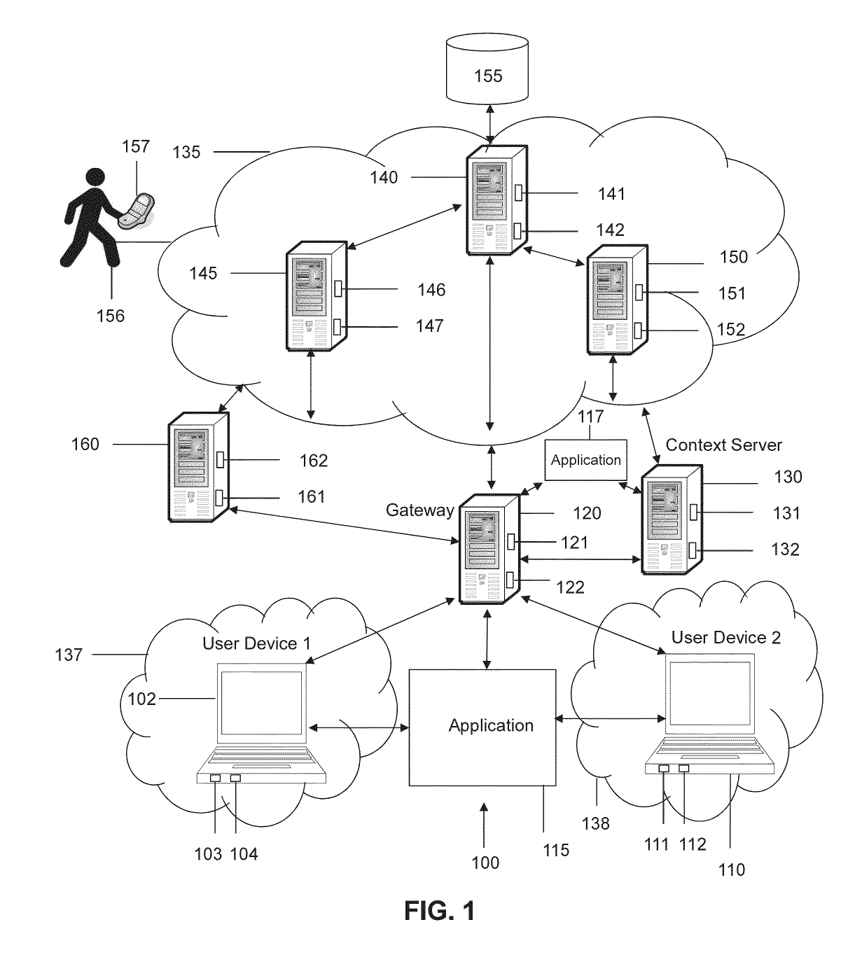

A system 100 and accompanying methods for monitoring and analyzing application data to proactively offer assistance are disclosed, such as shown in FIGS. 1-3. In particular, the system 100 and methods may allow an intelligent gateway 120 and a flexible rules-driven context server 130 to provide a dynamic and flexible end-to-end infrastructure for managing and sharing data between applications and contact/call center systems or other systems. Additionally, the gateway 120 and the context server 130 may be utilized by the system 100 and methods to deliver a seamless and user-integrated experience for a user seeking assistance from such contact/call center systems. In order to do so, an application 117 may be developed using a SDK, and the application 117 may then be utilized to monitor and capture a selected user's usage of a selected application 115. Once the application 117 monitors and captures the selected user's usage of the selected application 115, the system 100 and methods may be utilized to determine if the usage triggers one or more rules and/or triggers stored on the context server 130.

If the usage triggers one or more rules and/or triggers, the system 100 and methods may include determining that the user of the selected application 115 requires assistance. When the user is determined to need assistance, the system 100 and methods may include modifying a portion of the selected application 115 based on the user's usage and/or information collected on the user. The modified portion of the selected application 115 may be accessed by the user so that the user may be connected with an agent 156 of the contact/call center, connected with an online support system, connected with a virtual agent, or connected with other types of assistance mechanisms. Once the user connects with an agent 156, an online support system, or other type of assistance mechanism, the user may receive the assistance. Notably, as the user's usage of the application 115 changes over time, the portion of the selected application 115 and the type of assistance offered to the user may be adjusted accordingly.

Referring to the drawings and in particular to FIG. 1, the system 100 may provide an infrastructure for managing and sharing data, assistance, and media between applications and contact/call center systems or other systems. In certain embodiments, the system 100 may be configured to support, but is not limited to supporting, call center services, assistance services, online educational services, online medical services, business process services, cloud computing services, voice-over-internet protocol services (VoIP), software as a service (SaaS) applications, gaming applications and services, productivity applications and services, mobile applications and services, and any other computing applications and services. The system 100 may include a first user that may utilize user device 102 to access an application 115 that may provide various types of information, content, data, and services. Additionally, the system 100 may include a second user that may similarly utilize user device 110 to access the application 115 to gain access to various types of content and services. In certain embodiments, the user devices 102, 110 may be computers, servers, mobile devices, smartphones, computer tablets, phablets, or any other computing devices.

In one embodiment, the user device 102 may include a memory 103 that stores instructions, and a processor 104 that executes the instructions from the memory 103 to perform various operations that are performed by the user device 102. The processor 104 may be hardware, software, or a combination thereof. Similarly, the user device 110 may include a memory 111 that stores instructions, and a processor 112 that executes the instructions from the memory 111 to perform various operations that are performed by the user device 102. The processor 112 may be hardware, software, or a combination thereof. Illustratively, user devices 102, 110 are schematically shown as computer laptops in FIG. 1.

Additionally, the system 100 may include an intelligent gateway 120 that may serve as an intermediary device between the user devices 102, 110, the context server 130, the other devices in the system 100, and between the communications networks 135, 137, 138. The gateway 120 may include a memory 121 that includes instructions, and a processor 122 that executes the instructions from the memory 121 to perform various operations that are performed by the gateway 120. In certain embodiments, the gateway 120 may serve as an interface between the communications network 135 and the communications networks 137 and 138. For example, in certain embodiments, the communications network 135 may be a session initiation protocol (SIP) based network and the communications networks 137, 138 may be hypertext transfer protocol (HTTP) based networks. In such embodiments, the gateway 120 may serve as an interface between the SIP based network and the HTTP based networks. In other embodiments, the gateway 120 may serve as an interface between any types of networks using any types of protocols.

Furthermore, the system 100 may include a context server 130, which may be utilized to store one or more rules and/or triggers for the system 100. The rules and/or triggers may be utilized for providing a set of conditions that may be utilized by the system 100 to determine when a particular user needs assistance. For example, the rules and/or triggers may include, but are not limited to, a rule indicating that assistance is needed if a user has attempted to access a feature of the selected application 115 a threshold number of times, a rule indicating that assistance is needed if the user has been interacting with the selected application 115 for a threshold amount of time, a rule indicating that assistance is needed if the user has accessed the selected application 115 a threshold number of times, a rule indicating that assistance is needed if the user has accessed a designated feature or function of the selected application 115, a rule indicating that assistance is needed if a feature or function of the selected application 115 has failed when the user tried to use the feature or function, and a rule indicating that assistance is needed if the user has a user profile that includes information that indicates that the user needs assistance. In certain embodiments, the context server 130, alone or in combination with the other devices in the system 100, may determine when a particular rule or trigger has been satisfied based on monitoring and analyzing a given user's usage of the application 115.

The first user may utilize the user device 102, and the second user may utilize the user device 110 to access and interact with the application 115 so as to obtain various types of content and input various types inputs. The content and inputs may include audio content, video content, text content, image content, gaming content, web content, any other type of content, and information or data. Additionally, the first and second users may utilize the user devices 102, 110 to perform a variety of other tasks and functions using the application 115. In certain embodiments, the application 115 may be a client-side software application that may include, but is not limited to, an application for providing assistance, a business process application, a gaming application, an internet-based application, a browser application, a mobile application, a productivity application, a video application, a music application, a social media application, a web-based application, or any other type of application. In certain embodiments, at least a portion of the application 115 may be configured to execute directly on the user devices 102, 110, however, in other embodiments, the application 115 may be configured to execute on the other devices and components in the system 100, such as on the gateway 120. Also, in certain embodiments, the application 115 may be developed using a client-side SDK that ensures that the application 115 may appropriately interface with the application 117 and/or the devices in the system 100. For example, the client-side SDK may be utilized to implement an application programming interface (API) that can interface with an API of the application 117.

In certain embodiments, the application 115 may be utilized to provide various features and functions to the first and second users. For example, the application may be an educational application for use in an online learning environment, an investment website for enabling users to make investments and learn about investments, a news website for providing news to the users, a media website for providing media content to the users, a gaming application for allowing users to play a video game, or any other type of application. Notably, the functions and features of the application 115 may be unlimited in scope and type. For example, the application 115 may include media functions, calculation functions, user support functions, messaging functions, electronic mail functions, or any other types of functions that the application 110 may use to support the users. In certain embodiments, the application 115 may include a software-to-software interface that enables the application 115 to communicate with other applications in the system 100, such as application 117, to provide services and functionality needed to support the application 115. The application 115 may also include programming instructions and standards that enable the application 115 to access and communicate with one or more other applications in the system 100.

The application 117 may be a server-side application, that may be implemented using a server-side SDK so as to ensure that the application 117 appropriately interfaces with the application 115 and with the other devices and applications in the system 100. In certain embodiments, the application 117 may be any type of software application and may include any of the features and functionality of application 117. Additionally, the application 117 may include functions that may be utilized to monitor, capture, and analyze the first and second user's usage data with respect to the application 115. The usage data may be captured from the user devices 102, 110 via the application 115 and via the gateway 120. Also, the application 117 may compare the usage data collected from the users to determine if the users need any assistance. The application 117 may determine if the users need any assistance by comparing the usage data against the rules and/or triggers stored on the context server 130.

Additionally, the application 117 may be utilized to modify a portion of the application 115 to provide the first and second users with the ability to connect to an agent 156, an agent device 157, an online support system, a virtual agent, or with any other assistance mechanism. A virtual agent may be software program that provides online support, provides answers to inputted questions, and performs and of the typical functions of a human agent, such as agent 156. Once the first and/or second user accesses the modified portion of the application 115, the application 117 may assist in connecting the first and second users to the assistance mechanisms and/or actually provide at least a portion of the assistance to the first and second users. Furthermore, the application 117 may adjust the modified portion of the application 115, select the appropriate type of agent 156, and adjust the type of the assistance provided to the first and second users based on each user's usage data and based on information associated with each user. The agent 156 may be a human agent that may utilize agent device 157 to connect with either user device 102, user device 110, or both. Agent device 157 may include a processor that executes instructions from a memory of the agent device 157 to perform various operations of the agent device 157. Additionally, the agent device 157 may provide digital assistance mechanisms, such as online support associated with application 115, to each of the user devices 102, 110.

The application 115, the application 117, and the functions supported by the application 115 and application 117, may be supported and executed by using any combination of the gateway 120 and the servers 140, 145, and 150 in the communications network 135 or outside of the communications network 135. In one embodiment, the server 140 may include a memory 141 that includes instructions, and a processor 142 that executes the instructions from the memory 141 to perform various operations that are performed by the server 140. Additionally, the server 145 may include a memory 146 that includes instructions, and a processor 147 that executes the instructions from the memory 146 to perform various operations that are performed by the server 145. Furthermore, the server 150 may include a memory 151 that includes instructions, and a processor 152 that executes the instructions from the memory 151 to perform various operations that are performed by the server 150. The processors 142, 147, and 152 may be hardware, software, or a combination thereof. In certain embodiments, the servers 140, 145, and 150 may be network servers, routers, gateways, computers, mobile devices, or any other suitable computing device.

The communications network 135 of the system 100 may be configured to link each of the devices in the system 100 to one another, may be configured to be linked to the communications networks 137, 138, and may be configured to transmit, generate, and receive any information and data traversing the system 100. In one embodiment, the communications network 135 may include any number of additional servers in addition to the server 140, the server 145, and the server 150. The communications networks 135, 137, 138 may include and be connected to a SIP enabled network, a HTTP enabled network, a wireless network, an ethernet network, a satellite network, a broadband network, a cellular network, a private network, a cable network, the Internet, an internet protocol network, a multiprotocol label switching (MPLS) network, a H.323-enabled network, any other type of network, or any combination thereof. In certain embodiments, the communications network 137 may be associated with the user of the user device 102, and the communications network 138 may be associated with the user of the user device 110. In one embodiment, the communications networks 135, 137, 138 may be part of a single autonomous system that is located in a particular geographic region, or be part of multiple autonomous systems that span several geographic regions.

The database 155 of the system 100 may be utilized to store and relay information that traverses the system 100, store content that traverses the system 100, store data about each of the devices in the system 100, and perform any other typical functions of a database. In one embodiment, the database 155 may be connected to or reside within the communications network 135. Additionally, the database 155 may include a processor and memory or be connected to a processor and memory to perform the various operation associated with the database 155. In certain embodiments, the database 155 may be connected to user devices 102, 110, application 115, the application 117, gateway 120, context server 130, the servers 140, 145, 150, 160, and the agent device 157. The database 155 may also store information associated with the users in the system 100, user profiles for each user, monitored usage information for each user, behavioral information for each user, information relating to which features of the application 115 that each user typically uses, information relating to the typical type of assistance that each user typically seeks or needs, the rules used to trigger assistance for each user, session identifiers for each user, a list of agents for each user, software development kits associated with the application 115, 117, call information associated with calls conducted between an agent 156 and a user, and data generated, transmitted, or received by any of the devices in the system 100. Furthermore, the database 155 may be configured to process queries sent to it by any of the devices in the system 100.

Operatively, the system 100 for monitoring and analyzing application data to offer assistance may operate as described herewith. In a first example scenario, a first user may be searching for a number of investment opportunities on a bank's website or mobile application, which may be application 115. As the user is accessing the application 115, the system 100, such as via application 117, may monitor, capture and analyze the first user's usage of the application 115. The usage may include, but is not limited to, information indicating what web pages the user is accessing, information indicating how long the user is accessing the application 115, information indicating how often the user accesses the application 115, information indicating that the user was unable to access a feature of the application 115, information indicating a failure in the application 115, information indicating demographic information for the user, information indicating what type of inputs the user is making into the application 115, information indicating an age, name, internet protocol address, gender, marital status, educational status, investment experience, income level, or any other information associated with the user.

The system 100 may then determine if the monitored usage of the first user triggers a rule residing on the context server 130. For example, if the first user attempted to access an investment page (e.g. a savings application page) of the application 115 five times, but was still unable to access the feature of the application 115, a rule indicating that assistance should be offered at five attempts may be triggered based on the user attempting to access the feature five times. If the monitored usage triggers a rule, then the system 100 may determine that the user needs assistance based on the triggering of the rule and based on the user's usage and information associated with the user. The system 100 may then modify a portion of the application 115 so that the user may be connected to an agent 156, an agent device 157, an online support system, a virtual agent, or any other type of assistance mechanism. For example, the system 100 may modify the investment page to include a button and chat dialogue box to connect with the agent 156. Once the user selects the button or other modified feature on the application 115, the user may be connected with the agent 156 via the agent device 157 and the user device 102.

Notably, the agent 156 may be selected based on the monitored usage performed by the user and/or based on information collected for the user. For example, if the user has a user profile indicating that the user is sixty years old, has limited investment experience, and that the user is a new user, and that the monitored usage indicates that the user is having trouble accessing the features of the investment page, the system 100 may select an agent 156 that has characteristics tailored to be best suited for interacting with the user. For example, the selected agent 156 may be agent in his or her sixties that has substantial investment experience. Similarly, the system 100 may select an online support system that includes comprehensive investment information for new users and has step-by-step instructions for assisting the user with the investment page. However, if the user is an experienced investor, the system 100 may provide the step-by-step instructions for using the investment page, but not provide the comprehensive investment information. The system 100 may also provide usage information, user profiles, and other user-related information to the agent 156, virtual agent, or online support system that is relevant to the user prior to the user connecting with the agent 156, virtual agent, or online support system. In this way, the agent 156, virtual agent, or online support system will be prepared to interact with each specific user prior to interacting with each user.

If the user is connecting to the agent 156, the system 100 may establish a call or other type of connection between the agent 156 and the user. During establishment of the call or at another designated time, a common session identifier may be added to the call. The common session identifier may be a unique number sequence, character string, or any other type of identifier that may be utilized to provide the agent 156 with any relevant data collected for the user. For example, the common session identifier may provide user profile information for the specific user so that the agent 156 is prepared to interact with the user prior to actually interacting with the user. Similarly, if the user is connecting with the virtual agent or the online support system, the common session identifier may be similarly used to share the user's usage information and user profile information with the virtual agent and/or online support system so that the virtual agent and/or online support system are adjusted to the user's needs.

As another example scenario, a second user may be using user device 110 to access the application 115, which, in this case may be an application that provides an online learning environment for students at a university. The second user's usage of the application 115 may be monitored and analyzed by the system 100. As an example, the monitored usage of the second user may indicate that the second user was struggling with or failing an educational exercise on the application 115. Based on the monitored usage, a rule may be triggered that will cause the system 100 to offer the user the ability to engage with a live tutor, which may be an agent 156 in this scenario. For example, the system 100 may modify the application 115 to display a web page that provides the second user with the option to connect with the tutor. Once the second user selects the option to connect with the tutor, the system 100 may establish a call between the second user and the tutor. The call may include a common session identifier, which may be utilized to obtain the second user's information, so that the tutor is aware of the user's usage information (e.g. struggling or failing the educational exercise in this case), user profile information, or other information associated with the second user when the tutor interacts with the second user.

Notably, the system 100 may adjust portions of the application 115 in real-time based on changes in monitored usage, based on changes in user profiles, based on the type of device a user is using, or based on any information associated with the user. Additionally, the system 100 may be configured to determine each user's habits and behaviors with respect to the application 115, and may be able to proactively offer assistance to the user based on the determined habits and behaviors—even prior to a rule being triggered. Thus, the system 100 may offer a seamless and user-integrated experience for each specific user interacting with the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, monitoring the user's usage of the selected application 115, determining if the usage of the application 115 triggers a rule associated with the application 115, determining whether or not the user needs assistance, modifying portions of the selected application 115 based on the user's usage and/or information associated with the user, presenting the modified portion of the selected application 115 to the user, providing the user with access to assistance, and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIG. 1 illustrates specific example configurations of the various components of the system 100, the system 100 may include any configuration of the components, which may include using a greater or lesser number of the components. For example, the system 100 is illustratively shown as including a user device 102, a user device 110, an application 115, application 117, a gateway 120, a context server 130, a communications network 135, a communications network 137, a communications network 138, a server 140, a server 145, a server 150, an agent 156, an agent device 157 a server 160, and a database 155. However, the system 100 may include multiple user devices 102, 110, multiple applications 115, 117, multiple communications networks 135, 137, 138, multiple context servers 130, multiple servers 140, 145, 150, and 160, multiple agents 156, multiple agent devices 157, multiple databases 155, or any number of any of the other components in the system 100. Furthermore, in one embodiment, substantial portions of the functionality and operations of the system 100 may be performed by other networks and systems that may be connected to system 100.

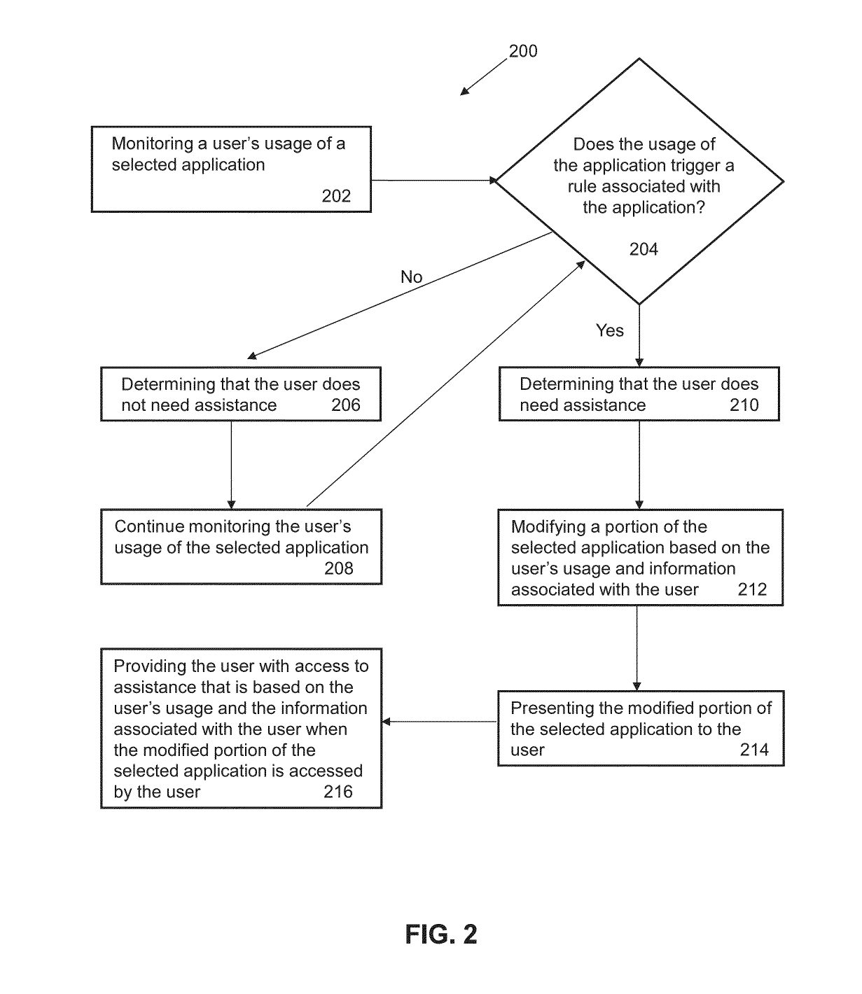

As shown in FIG. 2, an exemplary method 200 for monitoring and analyzing application data to offer assistance is schematically illustrated, and may include, at step 202, monitoring and/or capturing a user's usage of a selected application. The user's usage may include information that includes, but is not limited to, an identification of the features of the selected application 115 that are used by the user, information relating to the user's interaction with the selected application 115, information identifying the user's inputs into the selected application 115, information indicating the amount of time the user has accessed the selected application 115, information indicating the frequency that the user uses the selected application 115, information indicating how the user accesses the selected application 115, information indicating the type of device that the user uses to access the selected application 115, and any information associated with the user. In certain embodiments, the monitoring and/or capturing of the user's usage may be performed by the application 117, the gateway 120, the context server 130, the servers 140, 145, 150, 160, any combination thereof, or by any other appropriate device.

At step 204, the method 200 may include determining if the usage of the selected application 115 triggers a rule associated with the application 115. The rule may include, but is not limited to, a rule indicating that assistance is needed if a threshold number of times that the user has attempted to access a feature of the selected application 115, a rule indicating that assistance is needed if the user has been interacting with the selected application 115 for a threshold amount of time, a rule indicating that assistance is needed if the user has accessed the selected application 115 a threshold amount of times, a rule indicating that assistance is needed if the user has accessed a designated feature or function of the selected application 115, a rule indicating that assistance is needed if a feature or function of the selected application 115 has failed when the user tried to use the feature or function, and a rule indicating that assistance is needed if the user has a user profile that includes information that indicates that the user needs assistance. In certain embodiments, the determination of the triggering of the rule may be performed by the application 117, the gateway 120, the context server 130, the servers 140, 145, 150, 160, any combination thereof, or by any other appropriate device.

If the monitored usage of the selected application 115 does not trigger a rule associated with the application, the method 200 may include, at step 206, determining that the user does not need any assistance. If the user is determined to not need assistance, the method 200 may include, at step 208, continuing to monitor the user's usage of the selected application 115. In certain embodiments, the continued monitoring of the user's usage may be performed by the application 117, the gateway 120, the context server 130, the servers 140, 145, 150, 160, any combination thereof, or by any other appropriate device. As the user's usage continues to be monitored, the method 200 may proceed back to step 204 and repeat the process. However, if the monitored usage of the selected application 115 does trigger the rule associated with the application 115, the method 200 may include, at step 210, determining that the user does need assistance. In certain embodiments, the determination as to whether the user needs assistance may be performed by the application 117, gateway 120, the context server 130, the servers 140, 145, 150, 160, any combination thereof, or by any other appropriate device.

If the user is determined to need assistance, the method 200 may include modifying a portion of the selected application 115 at step 212. In certain embodiments, the portion of the selected application 115 may be modified based on the user's usage, based on information gathered about the user, or based on a combination thereof. In certain embodiments, the modification of the portion of the selected application 115 may be performed by the application 117, the gateway 120, the context server 130, the servers 140, 145, 150, 160, any combination thereof, or by any other appropriate device. At step 214, the method 200 may include presenting the modified portion of the selected application 115 to the user, such as via a graphical user interface of the application 115. In certain embodiments, the presenting may be performed and/or assisted by the user device 102, the gateway 120, the context server 130, the servers 140, 145, 150, 160, any combination thereof, or by any other appropriate device. At step 216, the method 200 may include providing the user with access to the assistance when the modified portion of the selected application 115 is accessed by the user. In certain embodiments, the user may be provided with the assistance by utilizing the application 117, the gateway 120, the context server 130, the servers 140, 145, 150, 160, the agent device 157, any combination thereof, or by any other appropriate device. Notably, the assistance provided to the user may be tailored to correlate to the monitored usage of the user and/or tailored to correlate to information associated with the user.

In certain embodiments, the system 100 and methods may provide for additional functionality and features. For example, when the modified portion of the selected application 115 is accessed by the user, the system 100 and methods may include identifying an agent 156 that is the most appropriate for the user's needs. The agent 156 may be identified and selected based on the monitored usage of the selected application 115 and/or on gathered information associated with the users. Once the agent 156 is identified and selected, the system 100 and methods may include establishing a call or other type of connection between the agent 156 and the user. During establishment of the call or at another designated time, a common session identifier may be added to the call. The common session identifier may be an unique number sequence, character string, or any other type of identifier that may be utilized to provide the agent 156 with any relevant data collected for the user. In certain embodiments, the relevant data collected for the user may be data that is collected for the user prior to the rule being triggered.

In other embodiments, the system 100 and methods may include storing information about the user in a user profile. For example, the user profile may include, but is not limited to, the user's name, address information, application usage information, age, demographic information, location, family history, behaviors, or any other information. The user profile may be utilized by the system 100 and methods to adjust the assistance provided to the user and to adjust portions of the selected application 115 in real-time so that the assistance and portions of the selected application 115 are tailored to the user's needs. In certain other embodiments, some or all of the features and functionality of the system 100 may be conducted by the application 115 itself.

It is important to note that the methods described above may incorporate any of the functionality, devices, and/or features of the system 100 and subsystems described above, or otherwise, and are not intended to be limited to the description or examples provided herein.

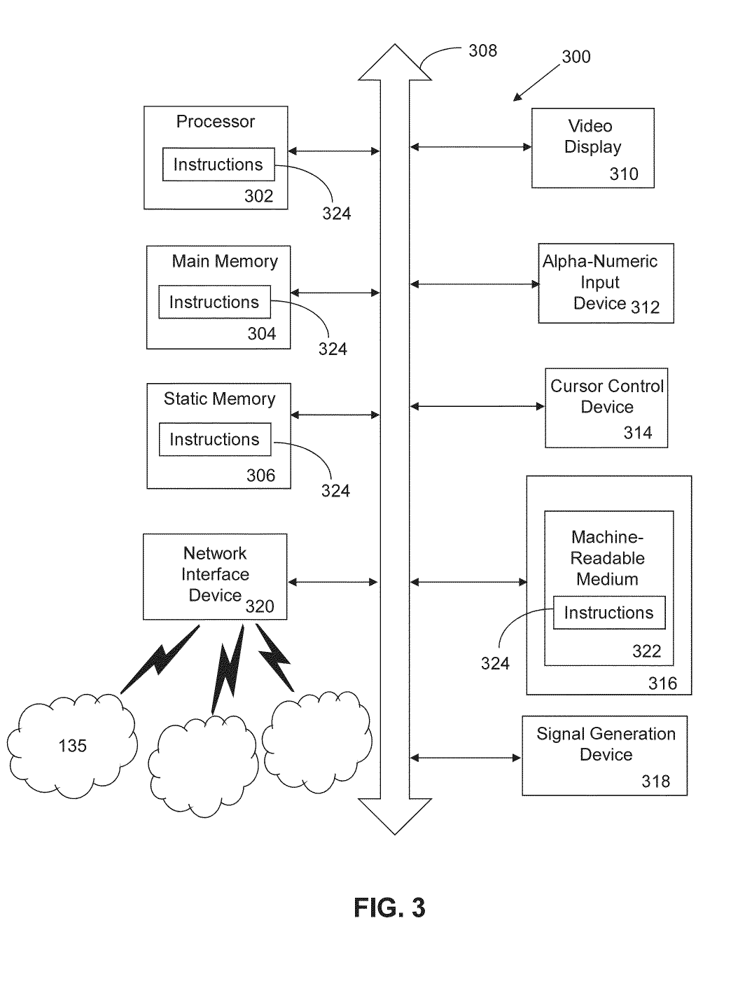

Referring now also to FIG. 3, at least a portion of the methodologies and techniques described with respect to the exemplary embodiments of the system 100 can incorporate a machine, such as, but not limited to, computer system 300, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected (e.g., using communications networks 135, 137, 138, another network, or a combination thereof) to and assist with operations performed by other machines, such as, but not limited to, user device 102, user device 110, the gateway 120, the context server 130, the server 140, the server 145, the server 150, the database 155, the agent device 157, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310, which may be, but is not limited to, a liquid crystal display (LCD), a flat panel, a solid state display, or a cathode ray tube (CRT). The computer system 300 may include an input device 312, such as, but not limited to, a keyboard, a cursor control device 314, such as, but not limited to, a mouse, a disk drive unit 316, a signal generation device 318, such as, but not limited to, a speaker or remote control, and a network interface device 320.

The disk drive unit 316 may include a machine-readable medium 322 on which is stored one or more sets of instructions 324, such as, but not limited to, software embodying any one or more of the methodologies or functions described herein, including those methods illustrated above. The instructions 324 may also reside, completely or at least partially, within the main memory 304, the static memory 306, or within the processor 302, or a combination thereof, during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium 322 containing instructions 324 so that a device connected to the communications networks 135, 137, 138, other network, or a combination thereof, can send or receive voice, video or data, and to communicate over the communications networks 135, 137, 138, other network, or a combination thereof, using the instructions. The instructions 324 may further be transmitted or received over the communications networks 135, 137, 138 other network, or a combination thereof, via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The terms “machine-readable medium” or “machine-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium” or “machine-readable device” may be non-transitory. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system for monitoring and analyzing application data to offer assistance, the system comprising:
a memory that stores instructions;
a processor that executes the instructions to perform operations, the operations comprising:
monitoring usage of an application, wherein the usage is performed by a user of the application;
determining if the usage of the application triggers a rule associated with the application;
determining that the user of the application needs assistance from the system if the usage of the application is determined to trigger the rule associated with the application; and
modifying a portion of the application if the user of the application is determined to need the assistance from the system, wherein the portion of the application enables the user to access the assistance from the system.

2. The system of claim 1, wherein the operations further comprise determining that the user of the application does not need the assistance from the system if the usage of the application is determined to not trigger the rule associated with the application.

3. The system of claim 1, wherein the operations further comprise connecting a device of the user to an assistance agent when the portion of the application that is modified is accessed.

4. The system of claim 1, wherein the rule associated with the application indicates a threshold number of attempts that the user can make to access a feature of the application, wherein the operations further comprise determining that the user of the application needs the assistance if the usage of the application indicates that the threshold number of attempts has been triggered.

5. The system of claim 1, wherein the rule associated with the application indicates a threshold duration for accessing a feature of the application, wherein the operations further comprise determining that the user of the application needs the assistance if the usage of the application indicates that the threshold duration for accessing the feature of the application has been triggered.

6. The system of claim 1, wherein the operations further comprise providing the assistance when the portion of the application that is modified is accessed, wherein the assistance that is provided is based on the usage of the application.

7. The system of claim 1, wherein the operations further comprise adjusting the portion of the application that enables the user to access the assistance from the system in correlation with a change in the usage of the application.

8. The system of claim 6, wherein the operations further comprise adjusting the assistance provided by the system based on the change in the usage of the application.

9. The system of claim 1, wherein the operations further comprise determining a pattern of the usage of the application over time, wherein the operations further comprise modifying the application based on the pattern of the usage.

10. A method for monitoring and analyzing application data to offer assistance, the method comprising:
monitoring usage of an application, wherein the usage is performed by a user of the application;
determining, by utilizing instructions from memory that are executed by a processor, if the usage of the application triggers a rule associated with the application;
determining that the user of the application needs assistance if the usage of the application is determined to trigger the rule associated with the application; and
modifying a portion of the application if the user of the application is determined to need the assistance, wherein the portion of the application enables the user to access the assistance.

11. The method of claim 10, further comprising determining that the user of the application does not need the assistance if the usage of the application is determined to not trigger the rule associated with the application.

12. The method of claim 10, further comprising connecting a device of the user to an assistance agent when the portion of the application that is modified is accessed.

13. The method of claim 10, wherein the rule associated with the application indicates a threshold number of attempts that the user can make to access a feature of the application, and wherein the method further comprises determining that the user of the application needs the assistance if the usage of the application indicates that the threshold number of attempts has been triggered.

14. The method of claim 10, wherein the rule associated with the application indicates a threshold duration for accessing a feature of the application, and wherein the method further comprises determining that the user of the application needs the assistance if the usage of the application indicates that the threshold duration for accessing the feature of the application has been triggered.

15. The method of claim 10, further comprising providing the assistance when the portion of the application that is modified is accessed, wherein the assistance that is provided is based on the usage of the application.

16. The method of claim 10, further comprising adjusting the portion of the application that enables the user to access the assistance in correlation with a detected change in the usage of the application.

17. The method of claim 16, further comprising adjusting the assistance provided based on the detected change in the usage of the application.

18. The method of claim 10, further comprising determining a pattern of the usage of the application over time, and further comprising modifying the application based on the pattern of the usage.

19. The method of claim 10, further comprising establishing a call with a device associated with the user when the portion of the application that is modified is accessed, and further comprising adding a session identifier to the call with the device, wherein the session identifier enables an agent connected to the call to be provided with information associated with the user.

20. A computer-readable device comprising instructions, which when loaded and executed by a processor, cause the processor to perform operations comprising:
monitoring usage of an application, wherein the usage is performed by a user of the application;
determining if the usage of the application triggers a rule associated with the application;
determining that the user of the application needs assistance if the usage of the application is determined to trigger the rule associated with the application; and
modifying a portion of the application if the user of the application is determined to need the assistance, wherein the portion of the application enables the user to access the assistance.
